(19) United States
(12) Patent Application Publication
(10) Pub. No.: US 2007/0246085 A1
(43) Pub. Date: Oct. 25, 2007

(54) APPARATUS AND METHOD FOR PHOTORESIST REMOVAL PROCESSING

(75) Inventors: Takahiko Wakatsuki, Kanagawa-ken (JP); Naoya Hayamizu, Kanagawa-ken (JP); Hiroshi Fujita, Kanagawa-ken (JP); Akiko Saito, Kanagawa-ken (JP); Toshihide Hayashi, Kanagawa-ken (JP); Yukinobu Nishibe, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/625,026

(22) Filed: Jan. 19, 2007

(30) Foreign Application Priority Data
Jan. 20, 2006 (JP) 2006-12759

(51) Int. Cl. B08B 3/00

(52) U.S. Cl. 134/95.3

(57) ABSTRACT

A processing apparatus includes: a processing chamber configured to process a workpiece; a moving unit configured to move the workpiece in the processing chamber; a first nozzle; a partition member; an inlet provided in communication with the downstream space; and an outlet provided in communication with the upstream space. The first nozzle has a discharge port configured to discharge a processing liquid or a processing gas. The discharge port is opposed to a moving path of the workpiece and the processing liquid or the processing gas is discharged from the discharge port in a discharge direction directed to an upstream side of a moving direction of the workpiece relative to a direction perpendicular to the moving direction. The partition member partitions a space above the moving path in the processing chamber, and the space is partitioned at a position of the first nozzle into an upstream space on the upstream side of the moving direction and a downstream space on a downstream side of the moving direction.

### CROSS-REFERENCE TO RELATED APPLICATIONS

This application is based upon and claims the benefits of priority from the prior Japanese Patent Application No. 2006-012759, filed on Jan. 20, 2006; the entire contents of which are incorporated herein by reference

### BACKGROUND OF THE INVENTION

1. Field of the Invention

This invention relates to a processing apparatus and a processing method, and more particularly to a processing apparatus and a processing method suitable to removing photoresist used in lithography.

2. Background Art

When a processing liquid is supplied to a workpiece surface to remove resist or other residues, it is important to exclude the used processing liquid from the workpiece surface as soon as possible. At present, particularly for a large glass substrate, the removed resist reattaches to the substrate surface and significantly decreases the processing efficiency.

JP 2005-013854A (FIG. 3) discloses a configuration where a substrate is opposed to a recovery nozzle for recovering used gas and a guide plate parallel to the substrate. However, in this configuration, the used gas that cannot be recovered by the recovery nozzle spreads behind the recovery nozzle (upstream of the substrate transfer direction) and flows over the guide plate to the downstream of the substrate transfer direction. Thus the used gas may reattach to the processed portion of the substrate.

### SUMMARY OF THE INVENTION

According to an aspect of the invention, there is provided a processing apparatus including: a processing chamber configured to process a workpiece; a moving unit configured to move the workpiece in the processing chamber; a first nozzle having a discharge port configured to discharge a processing liquid or a processing gas, the discharge port being opposed to a moving path of the workpiece and the processing liquid or the processing gas being discharged from the discharge port in a discharge direction directed to an upstream side of a moving direction of the workpiece relative to a direction perpendicular to the moving direction; a partition member partitioning a space above the moving path in the processing chamber, the space being partitioned at a position of the first nozzle into an upstream space on the upstream side of the moving direction and a downstream space on a downstream side of the moving direction; an inlet provided in communication with the downstream space; and an outlet provided in communication with the upstream space

According to an aspect of the invention, there is provided a processing apparatus including: a processing chamber configured to process a workpiece; a moving unit configured to move the workpiece in the processing chamber; a partition member partitioning a space above the moving path in the processing chamber, the space being partitioned into an upstream space on the upstream side of the moving direction and a downstream space on a downstream side of a moving direction of the workpiece; and a first nozzle provided in a proximity of the partition member, the nozzle discharging a processing liquid or a processing gas to the workpiece in a discharge direction directed to the upstream side of the moving direction relative to a direction perpendicular to the moving direction in an airflow from the downstream space toward the upstream space.

According to an aspect of the invention, there is provided a processing method for processing a workpiece moving in a processing chamber by discharging a processing liquid or a processing gas from a first nozzle, the processing chamber having a space above a moving path of the workpiece, the space being partitioned at a position of the first nozzle into an upstream space on an upstream side of a moving direction of the workpiece and a downstream space on a downstream side of the moving direction, the processing method comprising: producing an airflow from the downstream space toward the upstream space; directing the first nozzle to a discharge direction directed to the upstream side of the moving direction relative to a direction perpendicular to the moving direction; and discharging the processing liquid or the processing gas to the workpiece.

### BRIEF DESCRIPTION OF THE DRAWINGS

FIG. 1 is a schematic view illustrating the inside configuration of a processing chamber in a processing apparatus according to an embodiment of the invention.

FIG. 2 is a schematic view of processing liquid supply lines to the processing chamber shown in FIG. 1.

FIG. 3 is an enlarged perspective view of the main part of the first nozzle shown in FIG. 1.

FIG. 4 is a schematic view illustrating the configuration of an inline processing system including the processing apparatus according to the embodiment of the invention.

FIG. 5 schematically shows the positional relationship between the first nozzle and a workpiece according to the embodiment of the invention.

FIG. 6 is a graph showing a temperature variation on the upstream and downstream side of the moving direction of a workpiece versus the angle θ of the first nozzle shown in FIG. 5.

### DETAILED DESCRIPTION OF THE INVENTION

Embodiments of the invention will now be described with reference to the drawings.

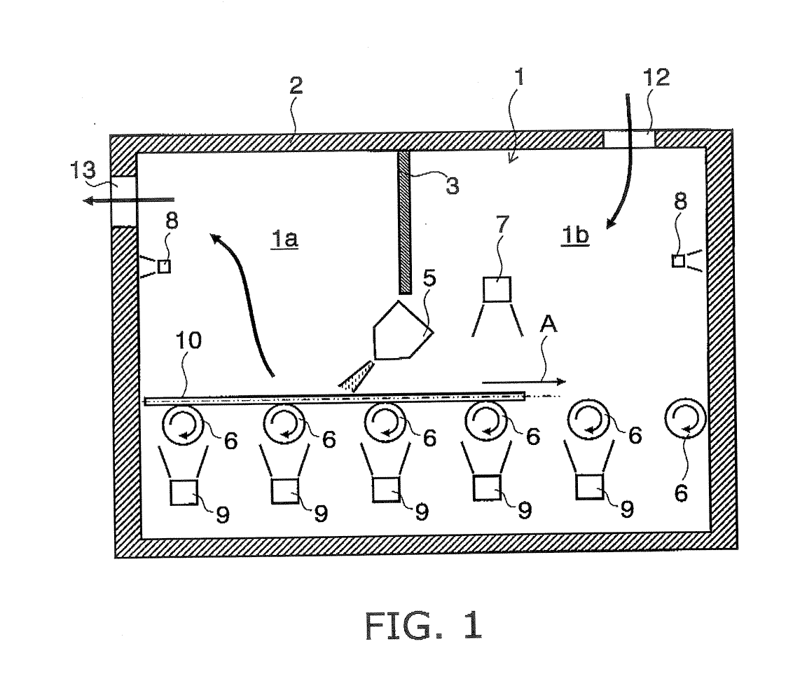

FIG. 1 is a schematic view illustrating the inside configuration of a processing chamber 1 in a processing apparatus according to an embodiment of the invention.

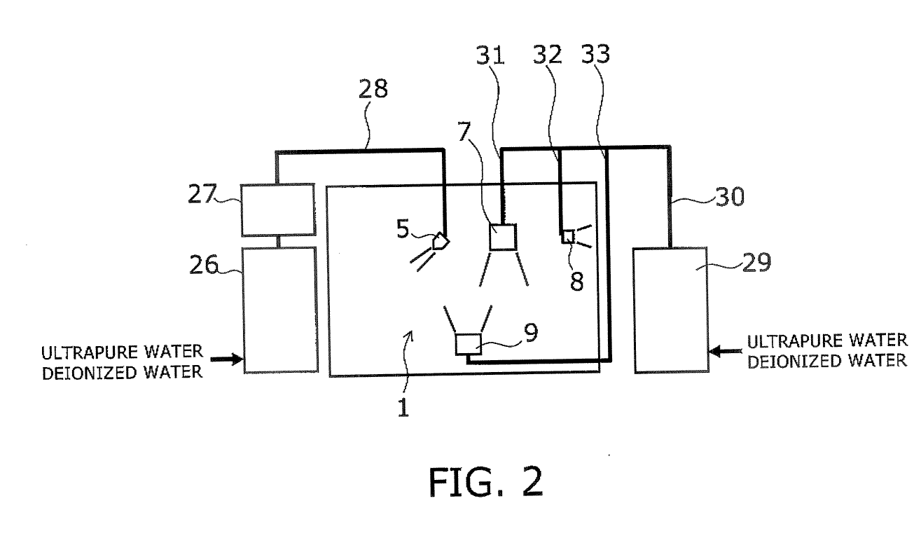

FIG. 2 is a schematic view of processing liquid supply lines to the processing chamber 1 shown in FIG. 1.

The processing apparatus according to this embodiment primarily comprises a processing chamber 1, a moving unit for moving a workpiece 10 in the processing chamber 1, a first nozzle 5, a second nozzle 7, third nozzles 9, fourth nozzles 8, and a partition member 3 for partitioning the space above the moving path of the workpiece 10 in the processing chamber 1, the space being partitioned at the first nozzle 5 into a space 1a on the upstream side of the moving direction A of the workpiece 10 and a space 1b on the downstream side of the moving direction A.

The workpiece 10 is, for example, a glass substrate for a liquid crystal panel. However, the workpiece 10 is not limited thereto, but may be a substrate for a flat panel display, a semiconductor wafer, a lead frame, a printed wiring board, or the like.

In the processing chamber 1, a plurality of transfer rollers 6 are provided along the moving direction A of the workpiece 10. The transfer rollers 6 are rotatable while supporting the workpiece 10. The workpiece 10 is moved in the moving direction A on the transfer rollers 6. The moving path of the workpiece 10 is imaginarily indicated by a double-dot dashed line in FIG. 1. The workpiece 10 of up to 1.1 meters wide, for example, can be transferred by these transfer rollers 6. The transfer rate can be varied from 1 to 10 meters/min, for example. In addition to the transfer rollers 6, the moving unit for the workpiece also includes shafts, motors, driving force transmission mechanisms, and the like, which are not shown.

In the upper portion of the processing chamber 1 is provided a plate-like partition member 3. Specifically, the partition member 3 is provided so as to hang from the upper face of the wall 2 of the processing chamber 1. The partition member 3 extends in the direction passing through the page in FIG. 1 and partitions the space above the moving path of the workpiece 10 in the processing chamber 1 into a space 1a on the upstream side of the moving direction A of the workpiece 10 and a space 1b on the downstream side of the moving direction A.

In the upper face of the wall 2 on the downstream side of the moving direction A with respect to the partition member 3, an inlet 12 is formed in communication with the downstream space 1b. Through this inlet 12, clean air is allowed to flow from outside the processing chamber 1 into the downstream space 1b. The inlet 12 is not limited to being formed in the upper face of the wall 2, but may be formed in the side face (right side face in FIG. 1) of the wall 2.

In the side face of the wall 2 on the upstream side of the moving direction A with respect to the partition member 3 (left side face in FIG. 1), an outlet 13 is formed in communication with the upstream space 1a. The outlet 13 is formed in the side face at a position near the upper face of the wall 2, The outlet 13 is connected to an exhaust means (not shown). The outlet 13 is not limited to being formed in the side face of the wall 2, but may be formed in the upper face of the wall 2.

The first nozzle 5 is disposed between the transfer rollers 6 (moving path of the workpiece 10) and the partition member 3. The first nozzle 5 has a discharge port opposed to the moving path of the workpiece 10.

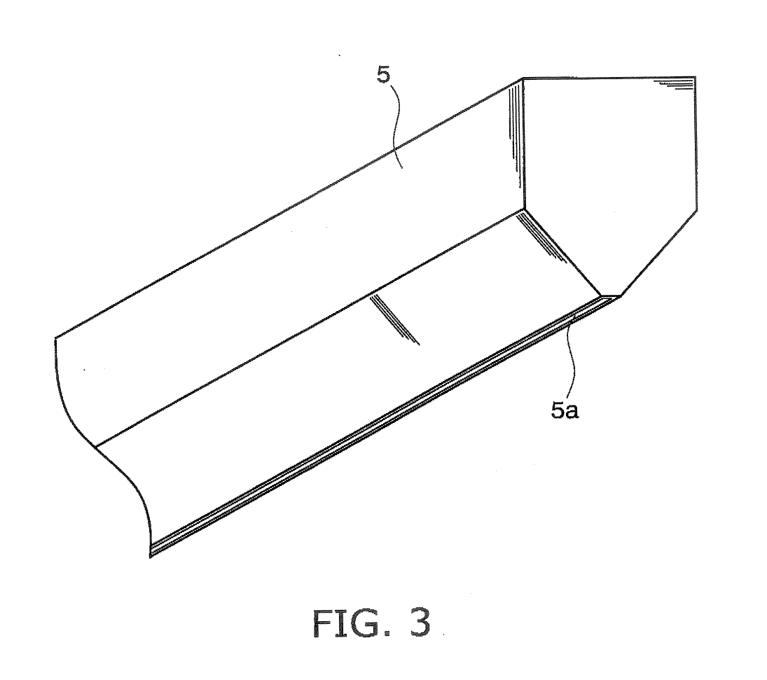

FIG. 3 is an enlarged perspective view of the main part of the first nozzle 5.

The first nozzle 5 extends in a bar shape. At the lower end thereof, a slit-shaped discharge port 5a is formed along the extending direction of the first nozzle 5.

From the discharge port 5a, the first nozzle 5 can discharge, singly or as a mixture, water, water vapor, water mist, chemical solution, chemical solution mist, chemical solution vapor, and the like, as a processing liquid for processing the workpiece 10.

The first nozzle 5 is tilted so that the processing liquid discharged from the discharge port 5a is directed to the upstream side of the moving direction A of the workpiece 10 relative to the direction perpendicular to the moving direction A. Thus the processing liquid discharged from the discharge port 5a is sprayed to the workpiece 10 in the upstream space 1a.

The first nozzle 5 extends in the direction passing through the page in FIG. 1 and partitions between the upstream space 1a and the downstream space 1b below the partition member 3. The slit-shaped discharge port 5a extends along the direction substantially orthogonal to the moving direction A (along the width of the workpiece 10).

In this embodiment, water vapor is discharged from the discharge port 5a of the first nozzle 5. As shown in FIG. 2, a vapor generator 26 and a vapor reheated 27 are provided outside the processing chamber 1. The vapor generator 26 generates vapor of ultra pure water or deionizer water. The vapor reheated 27 heats the generated vapor to a prescribed temperature. The heated vapor is passed through a piping 28 and discharged from the discharge port 5a of the first nozzle 5.

The flow rate of ultra pure water or deionizer water introduced into the vapor generator 26 for vapor generation is 4 to 10 liters/min, for example. The temperature of vapor discharged from the discharge port 5a of the first nozzle 5 can be controlled in the range of 100 to 140° C., for example.

Here, in light of temperature decrease due to adiabatic expansion that occurs when the water vapor is discharged into the atmosphere, the vapor generator 26 and the vapor reheated 27 are used to heat the water vapor to 180 to 300° C. so that the water vapor has a temperature of 100 to 140° C. on the surface of the substrate or other workpiece 10.

Immediately downstream of the position of the first nozzle 5 is provided a second nozzle 7, which has a discharge port opposed to the moving path. The direction of discharge from the second nozzle 7 is substantially perpendicular to the moving path.

Below the transfer rollers 6 are provided a plurality of third nozzles 9, each of which has a discharge port opposed to the transfer roller 6. The third nozzle 9 is placed on the other side of the moving path of the workpiece across the transfer roller 6.

A plurality of fourth nozzles 8 are provided so that their discharge ports are opposed to the inner sidewall of the wall 2 of the processing chamber 1. The fourth nozzles 8 are placed above the moving path of the workpiece.

Hot water is discharged from each of the second nozzle 7, the third nozzles 9, and the fourth nozzles 8. As shown in FIG. 2, a hot water generator 29 is provided outside the processing chamber 1. Hot water at a temperature of 95° C., for example, generated by the hot water generator 29 is supplied to the second nozzle 7, the third nozzles 9, and the fourth nozzles 8 through a piping 30 and piping's 31, 33, 32 branched from the piping 30.

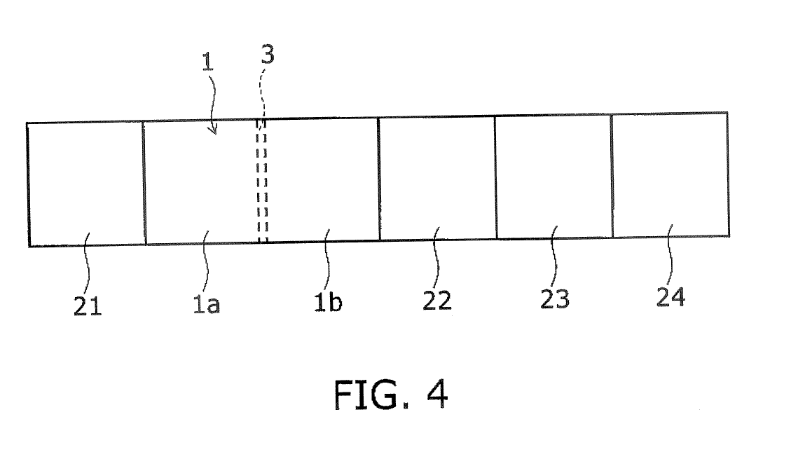

FIG. 4 is a schematic view illustrating the configuration of an inline processing system including the processing apparatus according to the embodiment of the invention.

A carry-in chamber 21 is disposed before the above-described processing chamber 1. A water rinse chamber 22, a drying chamber 23, and a carry-out chamber 24 are successively disposed after the processing chamber 1.

Next, the processing of the workpiece using the processing apparatus according to the embodiment of the invention is described.

A workpiece 10 is passed through the carry-in chamber 21 into the processing chamber 1 and moved along the moving direction A in the processing chamber 1 by the rotation of the transfer rollers 6.

At this time, water vapor is discharged from the first nozzle 5 toward the workpiece 10. The temperature and impact of this water vapor swells, peels, and blows off the photoresist or other residues formed on the workpiece 10.

Here, in this embodiment, the space above the moving path of the workpiece 10 in the processing chamber 1 is partitioned with the partition member 3 and the first nozzle 5 into a space 1a on the upstream side of the workpiece moving direction A and a space 1b on the downstream side. An airflow from the downstream space 1b toward the upstream space 1a is produced. The first nozzle 5 is tilted so that the discharge direction of the first nozzle 5 is directed to the upstream side of the moving direction A relative to the direction perpendicular to the moving direction A. Under this condition, water vapor is discharged to the workpiece 10. Therefore the photoresist peeled and blown from the workpiece 10 is prevented from scattering into the downstream space 1b . Part of the photoresist is moved with the airflow and ejected outside the processing chamber 1 through the outlet 13.

As a result, the photoresist peeled from the first nozzle 5 by the discharge of water vapor is prevented from scattering and reattaching to the processed portion (peeled portion) on the workpiece 10 that has proceeded downstream of the position of the first nozzle 5. Thus the processing efficiency is improved.

Furthermore, in this embodiment, the amount of exhaust from the outlet 13 is made larger than the flow rate of water vapor discharged from the first nozzle 5. This makes it more difficult for the peeled and blown photoresist to scatter downstream.

Downstream of the first nozzle 5, hot water is sprayed to the workpiece 10 at a high pressure of 0.3 mega Pascal, for example. Thus the photoresist remaining on the workpiece 10 can be removed.

In this embodiment, a chemical for facilitating dissolution of the photoresist can also be added to the water vapor discharged from the first nozzle 5 to remove the photoresist remaining on the workpiece 10. In this case, water vapor, and water produced by condensation of the water vapor after the processing, with photoresist ingredients being dissolved therein, remain on the processed portion of the substrate or other workpiece 10 Such water vapor and water may be naturally cooled down and recoagulated on the surface of the substrate or other workpiece 10.

Here, in this embodiment, the second nozzle 7 is placed at a prescribed position such as a position immediately downstream of the first nozzle 5. By the supply of hot water sprayed therefrom, water with photoresist ingredients being dissolved therein can be washed away from the substrate or other workpiece 10 before the photoresist ingredients are recoagulated.

A portion of the photoresist peeled from the workpiece 10 is mixed in the water vapor discharged from the first nozzle 5 or the water produced by the cooling of this water vapor and ejected through a water outlet (not shown). Another portion of the photoresist may be attached to the transfer rollers 6, and then attached to the backside of the workpiece 10 supported on the transfer rollers 6. However, in this embodiment, extraneous matter attached to the transfer rollers 6 and the backside of the workpiece 10 can be washed away by a shower of hot water discharged from the third nozzles 9.

In addition to cleaning extraneous matter attached to the transfer rollers 6 and the backside of the workpiece 10, the third nozzles 9 also serve to increase the temperature of the workpiece 10 by heating it from its backside, thereby enhancing the peeling effect of the water vapor.

Part of the photoresist peeled and blown from the workpiece 10 may be scattered upward in the processing chamber 1 and attached to the inner side face of the wall 2. However, in this embodiment, extraneous matter attached to the inner side face of the wall 2 is washed away by the hot water discharged from the fourth nozzles 8 and ejected outside the processing chamber 1 together with wastewater. Thus the extraneous matter attached to the inner side face of the wall 2 is prevented from falling on and reattaching to the workpiece 10.

The workpiece 10 from which the photoresist or other residues have been removed in the processing chamber 1 as described above is subsequently transferred to the water rinse chamber 22, where the workpiece 10 is rinsed with water. Next, in the drying chamber 23, the workpiece 10 is dried with air knife, for example. Then the workpiece 10 is passed to the subsequent process through the carry-out chamber 24.

Next, a description is given of temperature measurements on the upstream and downstream side of the workpiece moving direction A for various discharge directions of the first nozzle 5.

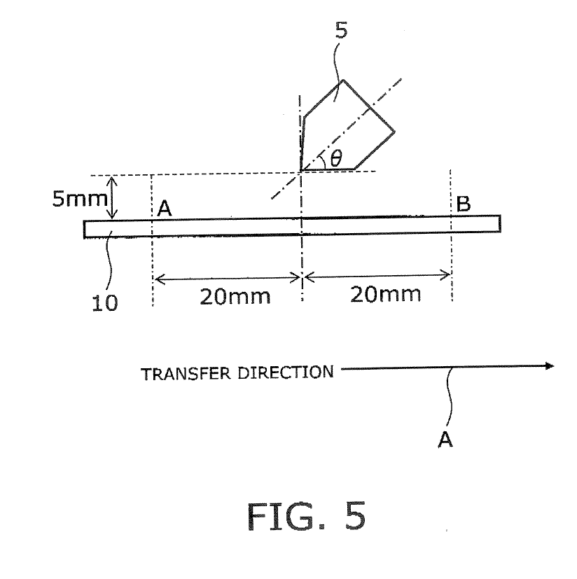

Specifically, temperatures at an upstream point A and a downstream point B along the moving direction A were measured for various values of angle θ shown in FIG. 5. Here, the angle θ refers to an angle between the moving direction A of the workpiece 10 and the discharge direction of the first nozzle 5. When the discharge direction of the first nozzle 5 is perpendicular to the workpiece 10, the angle θ is 90°.

The workpiece 10 used was a glass substrate with a photoresist of novolac resin being applied on the frontside thereof. The spacing between the discharge port of the first nozzle 5 and the workpiece 10 was set to 5 mm. The temperature measurement point A was set to a position located 20 mm upstream of the discharge port of the first nozzle 5, and the temperature measurement point B was set to a position located 20 mm downstream of the discharge port of the first nozzle 5. The discharge flow rate of water vapor was 50 milllliters/min, and the preset temperature of the water vapor was set to 180° C.

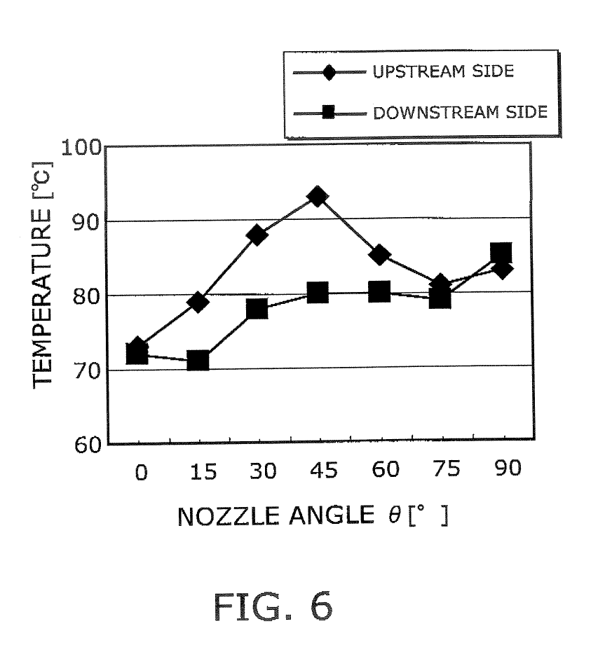

TABLE 1 and FIG. 6 show the measurement result.

In FIG. 6, the horizontal axis represents the angle θ of the first nozzle 5, and the vertical axis represents the temperatures measured at the upstream point A and the downstream point B.

TABLE 1

| | | TEMPERATURE AT |
|---|---|---|
| NOZZLE | TEMPERATURE AT | DOWNSTREAM |
| ANGLE θ [°] | UPSTREAM POINT A [° C.] | POINT B [° C.] |
| 0 | 73 | 72 |
| 15 | 79 | 71 |
| 30 | 88 | 78 |
| 45 | 93 | 80 |
| 60 | 85 | 80 |
| 75 | 81 | 79 |
| 90 | 83 | 85 |

When the discharge direction of the first nozzle 5 is perpendicular to the workpiece 10 (the angle θ is 90°), the temperature at the upstream measurement point A is nearly equal to the temperature at the downstream measurement point B. This indicates that the vapor discharged from the first nozzle 5 flows evenly to both the upstream and downstream side. That is, by the flow of vapor to the downstream side, the blown and peeled matter is likely to reattach to the processed portion of the workpiece 10. Actually, in this case, attachment of photoresist onto the processed workpiece 10 was confirmed.

In contrast, when the discharge direction of the first nozzle 5 is tilted to the upstream side (the angle θ is 15 to 75°), the substrate temperature at the upstream measurement point A is higher than the temperature at the downstream measurement point B. This indicates that the vapor discharged from the first nozzle 5 flows more to the upstream side than to the downstream side. That is, the flow rate of vapor to the downstream side is reduced, and the mist and peeled resist are prevented from penetrating into the downstream side. This prevents contamination on the processed portion of the workpiece 10. Furthermore, in this case, the amount of residues on the surface of the processed workpiece 10 is decreased relative to the case where water vapor is discharged perpendicularly to the workpiece 10.

In particular, when the angle θ is near 45°, there is a high temperature difference between points A and B. Therefore, for the purpose of preventing the peeled matter from reattaching to the workpiece 10, it is more preferable to discharge water vapor by tilting the discharge direction of the first nozzle 5 by 45° to the upstream side.

In this embodiment, as described above, the first nozzle 5 in the processing chamber 1 is tilted so that the discharge direction of the first nozzle 5 is directed to the upstream side of the moving direction A relative to the direction perpendicular to the moving direction A. Here, in an aspect of the embodiment, the first nozzle 5 in the processing chamber 1 may be fixed previously so that the discharge direction of the processing liquid has a prescribed angle relative to the moving direction A. In another aspect, the first nozzle 5 may be movably configured so that the discharge direction of the processing liquid has a prescribed angle relative to the moving direction A. Any of these aspects can be appropriately applied as part of the configuration of the processing apparatus in this embodiment.

Embodiments of the invention have been described with reference to the examples. However, the invention is not limited thereto, but various modifications can be made within the spirit of the invention.

The invention is not limited to removal of photoresist or other residues, but is also effective for simple cleaning. Furthermore, the workpiece, processing liquid, specific processing conditions and the like are also not limited to those described above

1. A processing apparatus comprising:
a processing chamber configured to process a workpiece;
a moving unit configured to move the workpiece in the processing chamber;
a first nozzle having a discharge port configured to discharge a processing liquid or a processing gas, the discharge port being opposed to a moving path of the workpiece and the processing liquid or the processing gas being discharged from the discharge port in a discharge direction directed to an upstream side of a moving direction of the workpiece relative to a direction perpendicular to the moving direction;
a partition member partitioning a space above the moving path in the processing chamber, the space being partitioned at a position of the first nozzle into an upstream space on the upstream side of the moving direction and a downstream space on a downstream side of the moving direction;
an inlet provided in communication with the downstream space; and
an outlet provided in communication with the upstream space.

2. The processing apparatus according to claim 1, further comprising a second nozzle provided downstream of the moving direction relative to the first nozzle and having a discharge port opposed to the moving path.

3. The processing apparatus according to claim 1, wherein the moving unit has a transfer roller being rotatable while supporting the workpiece, the processing apparatus further comprising:
a third nozzle provided on an opposite side of the moving path across the transfer roller and having a discharge port opposed to the transfer roller.

4. The processing apparatus according to claim 1, further comprising a fourth nozzle having a discharge port opposed to an inner wall of the processing chamber.

5. The processing apparatus according to claim 1, wherein the moving direction of the workpiece makes an angle θ of 15 to 75° with the discharge direction of the first nozzle.

6. The processing apparatus according to claim 5, wherein the angle θ is substantially 45°.

7. The processing apparatus according to claim 1, wherein the first nozzle extends in a direction partitioning between the upstream space and the downstream space.

8. A processing apparatus comprising;
a processing chamber configured to process a workpiece;
a moving unit configured to move the workpiece in the processing chamber;
a partition member partitioning a space above the moving path in the processing chamber, the space being partitioned into an upstream space on the upstream side of the moving direction and a downstream space on a downstream side of a moving direction of the workpiece; and
a first nozzle provided in a proximity of the partition member,
the nozzle discharging a processing liquid or a processing gas to the workpiece in a discharge direction directed to the upstream side of the moving direction relative to a direction perpendicular to the moving direction in an airflow from the downstream space toward the upstream space.

9. The processing apparatus according to claim 8, further comprising a second nozzle provided downstream of the moving direction relative to the first nozzle and having a discharge port opposed to the moving path.

10. The processing apparatus according to claim 8, wherein the moving unit has a transfer roller being rotatable while supporting the workpiece, the processing apparatus further comprising:
a third nozzle provided on an opposite side of the moving path across the transfer roller and having a discharge port opposed to the transfer roller.

11. The processing apparatus according to claim 8, wherein the moving direction of the workpiece makes an angle θ of 15 to 75° with the discharge direction of the first nozzle

12. A processing method for processing a workpiece moving in a processing chamber by discharging a processing liquid or a processing gas from a first nozzle, the processing chamber having a space above a moving path of the workpiece, the space being partitioned at a position of the first nozzle into an upstream space on an upstream side of a moving direction of the workpiece and a downstream space on a downstream side of the moving direction, the processing method comprising:
producing an airflow from the downstream space toward the upstream space;
directing the first nozzle to a discharge direction directed to the upstream side of the moving direction relative to a direction perpendicular to the moving direction; and
discharging the processing liquid or the processing gas to the workpiece.

13. The processing method according to claim 12, wherein water vapor is discharged from the first nozzle.

14. The processing method according to claim 12, wherein the amount of exhaust from the upstream space is larger than the discharge flow rate of the processing liquid from the first nozzle.

15. The processing method according to claim 12, further comprising discharging a liquid from a second nozzle provided downstream of the moving direction relative to the first nozzle and having a discharge port opposed to the moving path.

16. The processing method according to claim 12, wherein the workpiece is moved by a transfer roller, the transfer roller being rotatable while supporting the workpiece, the processing method further comprising:
discharging a liquid from a third nozzle, the third nozzle being provided on an opposite side of the moving path across the transfer roller and having a discharge port opposed to the transfer roller.

17. The processing method according to claim 1, further comprising discharging a liquid from a fourth nozzle, the fourth nozzle having a discharge port opposed to an inner wall of the processing chamber.

18. The processing method according to claim 12, wherein the moving direction of the workpiece makes an angle θ of 15 to 75° with the discharge direction of the first nozzle.

19. The processing method according to claim 18, wherein the angle θ is substantially 45°.

20. The processing method according to claim 12, wherein the first nozzle extends in a direction partitioning between the upstream space and the downstream space.
